(19) United States
(12) Patent Application Publication
(10) Pub. No.: US 2009/0101642 A1
(43) Pub. Date: Apr. 23, 2009

(54) FUEL INLET STRUCTURE OF RESIN FUEL TANK, RESIN FUEL TANK HAVING FUEL INLET COMPONENT, AND METHOD FOR PRODUCING THE RESIN FUEL TANK

(75) Inventors: Kenji Muto, Wako (JP); Jun Nakajima, Wako (JP)

Correspondence Address: DITTHAVONG MORI & STEINER, P.C., 918 Prince St., Alexandria, VA, 22314, US

(73) Assignee: HONDA MOTOR CO., LTD., Tokyo (JP)

(21) Appl. No.: 12/210,631

(22) Filed: Sep. 15, 2008

(30) Foreign Application Priority Data
Oct. 19, 2007 (JP) 2007-273221

(51) Int. Cl. B65D 47/00; B29C 43/02

(52) U.S. Cl. 220/86.2; 264/517

(57) ABSTRACT

A fuel inlet structure of a resin fuel tank includes an upstanding portion and a fuel inlet. The upstanding portion is provided to the resin fuel tank molded by blow molding and stands upright in a cylindrical form. The fuel inlet is provided in the upstanding portion. The upstanding portion is formed by insert molding of a separate fuel inlet component in an integral manner during the blow molding of the tank. The fuel inlet component integrally includes a level plate portion extending downward below an upper surface of the tank.

### CROSS-REFERENCE TO RELATED APPLICATIONS

The present application claims priority under 35 U.S.C. §119 to Japanese Patent Application No. 2007-273221, filed Oct. 19, 2007. The contents of this application are incorporated herein by reference in their entirety.

### BACKGROUND OF THE INVENTION

1. Field of the Invention

The present invention relates to a resin fuel tank, a fuel inlet structure of the resin fuel tank, and a method for producing the resin fuel tank.

2. Discussion of the Background

A fuel tank molded entirely of a resin, and having a metallic level plate inserted in a fuel inlet thereof is disclosed in Japanese Patent Application Publication No. Hei 8-198161. The contents of Japanese Patent Application Publication No. Hei 8-198161 are incorporated herein by reference in their entirety.

Meanwhile, mounting a metallic level plate in a fuel inlet made of a resin as in the publicly known example improves toughness against falling down, but requires a structure for preventing looseness or fuel leakage. The structure for preventing fuel leakage requires, in addition to a packing of a fuel cap, a dedicated seal to be provided between a level plate and an upstanding portion, as well as a pressing cap for fixing the level plate. This results in an increase in the number of components and complicated structure. Also, since the level plate is provided separately from the upstanding portion, precise positioning of the level plate is burdensome.

### SUMMARY OF THE INVENTION

According to one aspect of the present invention, a fuel inlet structure of a resin fuel tank includes an upstanding portion and a fuel inlet. The upstanding portion is provided to the resin fuel tank molded by blow molding and stands upright in a cylindrical form. The fuel inlet is provided in the upstanding portion. The upstanding portion is formed by insert molding of a separate fuel inlet component in an integral manner during the blow molding of the tank. The fuel inlet component integrally includes a level plate portion extending downward below an upper surface of the tank.

According to another aspect of the present invention, a fuel inlet structure of a resin fuel tank includes a fuel inlet component which is connected to an upper surface of the resin fuel tank. The fuel inlet component includes a plate portion, an upstanding portion, and a level plate portion. The plate portion is connected to the upper surface of the resin fuel tank. The upstanding portion projects from the plate portion. A fuel inlet is provided in the upstanding portion. The level plate portion extends downward below the upper surface of the resin fuel tank. The fuel inlet component is connected to the upper surface of the resin fuel tank while the resin fuel tank is blow molded.

According to further aspect of the present invention, a resin fuel tank includes a fuel inlet component which is connected to an upper surface of the resin fuel tank. The fuel inlet component includes a plate portion, an upstanding portion, and a level plate portion. The plate portion is connected to the upper surface of the resin fuel tank. The upstanding portion projects from the plate portion. A fuel inlet is provided in the upstanding portion. The level plate portion extends downward below the upper surface of the resin fuel tank. The fuel inlet component is connected to the upper surface of the resin fuel tank while the resin fuel tank is blow molded.

According to further aspect of the present invention, a method for manufacturing a resin fuel tank includes providing a fuel inlet component having a lower surface, a plate portion, an upstanding portion, and a level plate portion. The plate portion has an upper face and a lower face. The upstanding portion projects from the upper face of the plate portion. The fuel inlet is provided in the upstanding portion. The level plate portion projects from the lower face of the plate portion. A resin material is blow molded to stick to the lower surface of the fuel inlet component to form the resin fuel tank.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a side view of a motorcycle provided with a fuel tank according to an embodiment of the present invention;

FIG. 2 is a side view of a first fuel tank as shown in FIG. 1;

FIG. 3 is a plan view of the first fuel tank as shown in FIG. 1;

FIG. 4 is a partially-enlarged cross-sectional view of a fuel inlet with a fuel cap attached thereto according to the embodiment of the present invention;

FIG. 5 is a cross-sectional view taken along the line 5-5 in FIG. 3; and

FIG. 6 is a view for describing a method for molding an upstanding portion according to an embodiment of the present invention.

### DESCRIPTION OF THE EMBODIMENTS

The embodiments will now be described with reference to the accompanying drawings, wherein like reference numerals designate corresponding or identical elements throughout the various drawings.

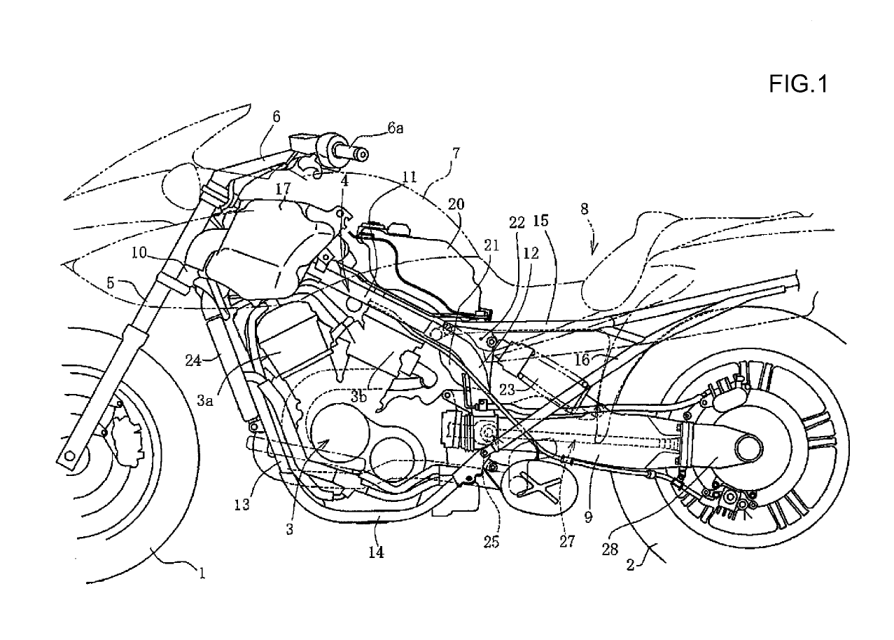

FIG. 1 is a side view of a motorcycle provided with a fuel tank according to an embodiment of the present invention. In the motorcycle, a power unit 3 is disposed between a front wheel 1 and a rear wheel 2 and supported by a vehicle body frame 4. Reference numeral 5 denotes a front fork, 6 denotes a handlebar, 7 denotes a tank cover, 8 denotes a seat, and 9 denotes a rear arm.

Grips 6a of the handlebar 6 are located above the top of the tank cover 7, and extend long rearward to reach positions above the bank space between a front cylinder 3a and a rear cylinder 3b.

The vehicle body frame 4 includes: a head pipe 10 supporting the front wheel 1 with the front fork 5 in between; main pipes 11 extending rearward above the power unit 3 from the head pipe 10; center pipes 12 disposed vertically behind the power unit 3; down pipes 13 extending downward in front of the power unit 3 from the head pipe 10; and lower pipes 14 disposed in the front-rear direction below the power unit 3. These pipes are continuously connected with each other so as to form a loop in which the power unit 3 is supported. Seat rails 15 extend rearward, and substantially horizontally, each from a vicinity of the connecting portion of the main pipe 11 and the center pipe 12. Also, the vehicle body frame 4 is provided with back stays 16 connecting obliquely between the center pipes 12 and the seat rails 15.

The front fork 5 is rotatably supported by the head pipe 10. The main pipes 11 are connected at the front end portions thereof to the head pipe 10, while the down pipes 13 are connected at the upper end portions thereof to the head pipe 10. An air cleaner 17 is supported, behind the head pipe 10, and in vicinities of the front end portions of the main pipes 11. A first fuel tank 20 is supported, behind the air cleaner 17, by the intermediate portions, in the front-rear direction, of the main pipes 11, and by the front portions of the seat rails 15.

A second fuel tank 21 is supported by the seat rails 15 behind and below the first fuel tank 20. The second fuel tank 21 is housed in a space surrounded by the center pipes 12, the seat rails 15, and the back stays 16. The front portion of the second fuel tank 21 vertically overlaps a part of the first fuel tank 20.

Each center pipe 12 is provided with, at a shoulder portion in an upper portion thereof, a stay 22 projecting upward and rearward, the shoulder portion being in a vicinity of a part at which the center pipe 12 is bent forward to be connected with the main pipe 11. A cushion unit 23 constituting a rear suspension is supported, at the upper portion thereof, by the stay 22. The stay 22 is disposed to be offset to the left of the vehicle body. The cushion unit 23 is slanted downward and extends rearward on the left side of the vehicle body, and is supported, at the lower end portion thereof, by the intermediate portion of the rear arm 9.

The power unit 3 includes a water-cooled, four-cycle, V engine having the front cylinder 3a and the rear cylinder 3b. The first fuel tank 20 is located above the rear-bank cylinder 3b. A radiator 24 is supported by the down pipes 13. Reference numeral 25 denotes a pivot shaft, which is provided at the intermediate portions, in the vertical direction, of the center pipes 12.

The rear arm 9 is vertically swingably supported, at the front end portion thereof, by the pivot shaft 25 provided at the intermediate portions, in the vertical direction, of the center pipes 12. The rear arm 9 supports, only at the right side of the rear end portion thereof, the rear wheel 2, like a cantilever.

The drive system of the rear wheel 2 is a shaft drive system. The rotational output of the power unit 3 is transmitted via a shaft drive mechanism 27 to a gear box 28 formed in a left portion of the rear end portion of the rear arm 9, so that the rear wheel 2 rotates.

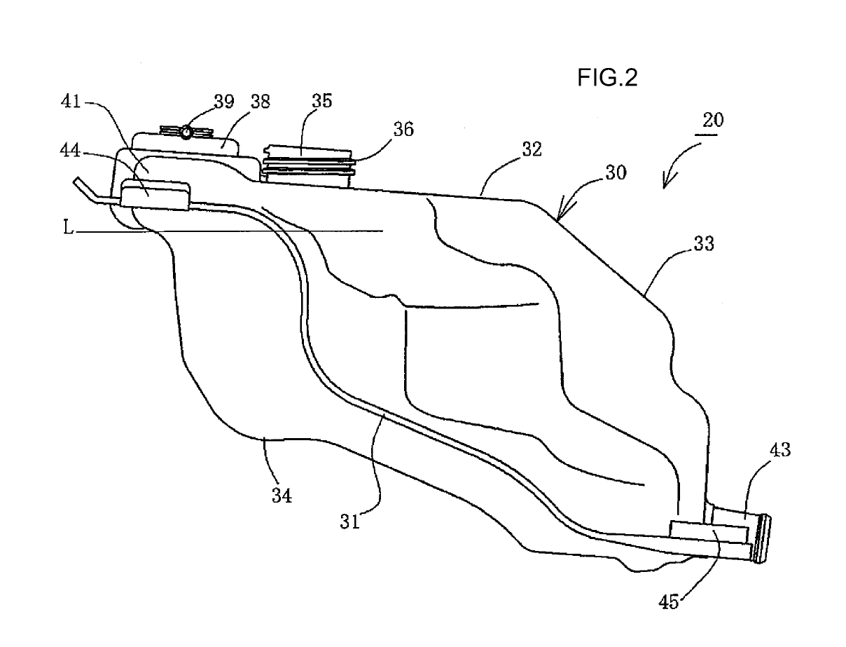

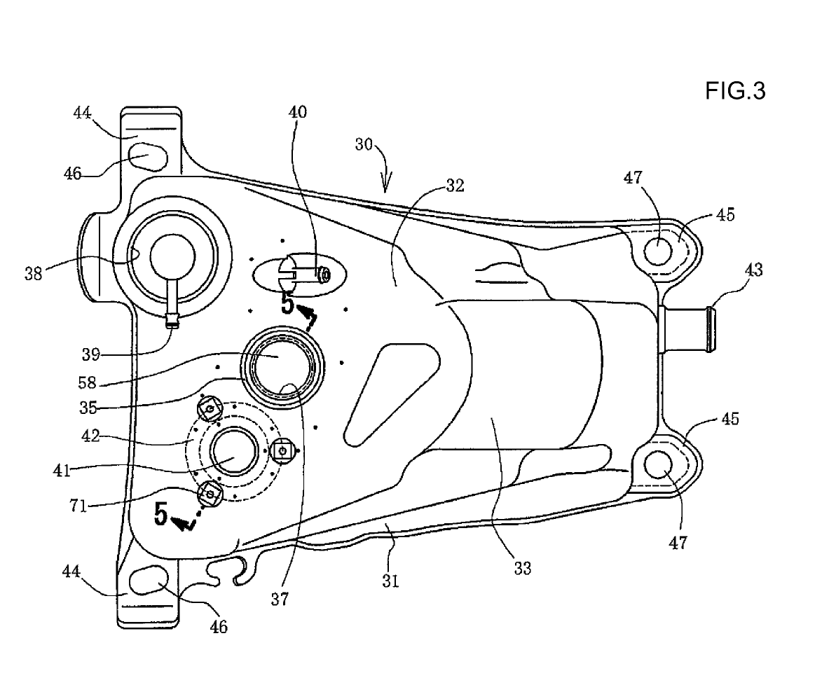

Next, the first fuel tank 20 will be described. FIG. 2 is a side view of the first fuel tank 20, and FIG. 3 is a plan view thereof. The first fuel tank 20 is wholly formed by blow molding using an appropriate thermoplastic resin made of polyethylene or the like, and has a hollow main body 30 and a flange 31 formed on, and project from, all the periphery of the side surface of the main body 30.

The main body 30 includes, in the upper portion thereof, a flat portion 32 and a back face portion 33 slanted downward, and includes, in the lower portion thereof, a bottom portion 34 slanted downward substantially as a whole.

A cylindrical upstanding portion 35 is formed integrally at the center of the flat portion 32. The upstanding portion 35 has a male thread 36 formed therearound, and has the upper end portion opened to serve as an opening portion 37 of a fuel inlet (see FIG. 3).

A breather portion 38 is provided on the right side of the front portion of the flat portion 32, and has a breather tube 39 projecting to the left of the vehicle body. A nozzle 40 projecting rearward is integrally formed behind the breather portion 38, and to the right of the upstanding portion 35. The nozzle 40 is an air bleed hole and communicates with the second fuel tank 21 via an unillustrated tube.

A mounting hole 41 for mounting a fuel sensor (not illustrated) is provided in the left side of the front portion of the flat portion 32 and has a mounting seat 42 provided therearound, on which the unillustrated fuel sensor is mounted.

The main body 30 has a pipe 43 formed to project rearward at the rear end portion thereof, and connected with the second fuel tank 21 with an unillustrated hose so as to allow the fuel in the first fuel tank 20 to be dropped into the second fuel tank 21.

As shown in FIG. 3, the flange 31 provided around the main body 30 has front and rear, right and left corner portions projecting outward to form front mounting portions 44 and rear mounting portions 45. The front mounting portions 44 are bolted, with oval holes 46 formed therein, to the upper surfaces of the main pipes 11, while the rear mounting portions 45 are bolted, with circular holes 47 formed therein, to the upper surfaces of the front portions of the seat rails 15 for installation on the frame. The mounting of the first fuel tank 20 is adjusted with the front mounting portions 44.

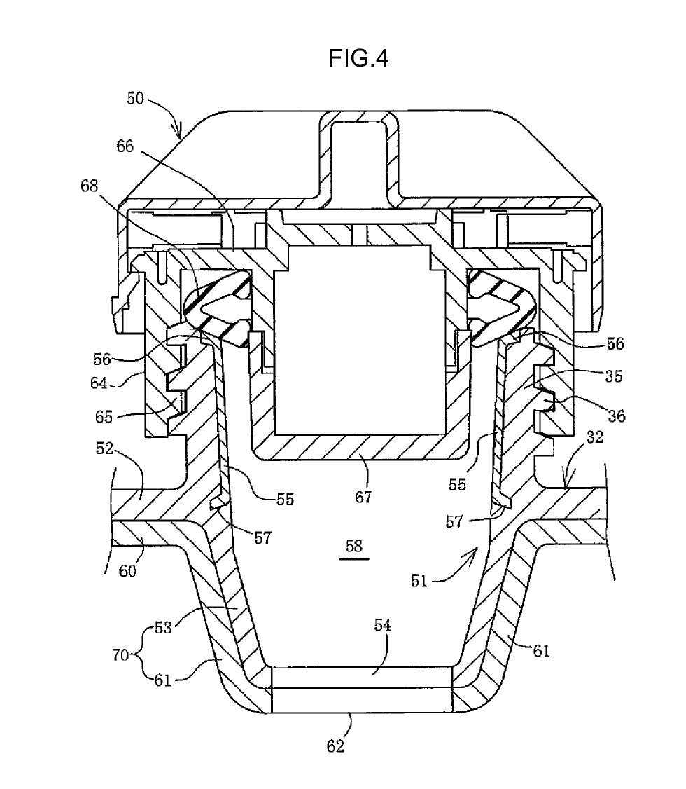

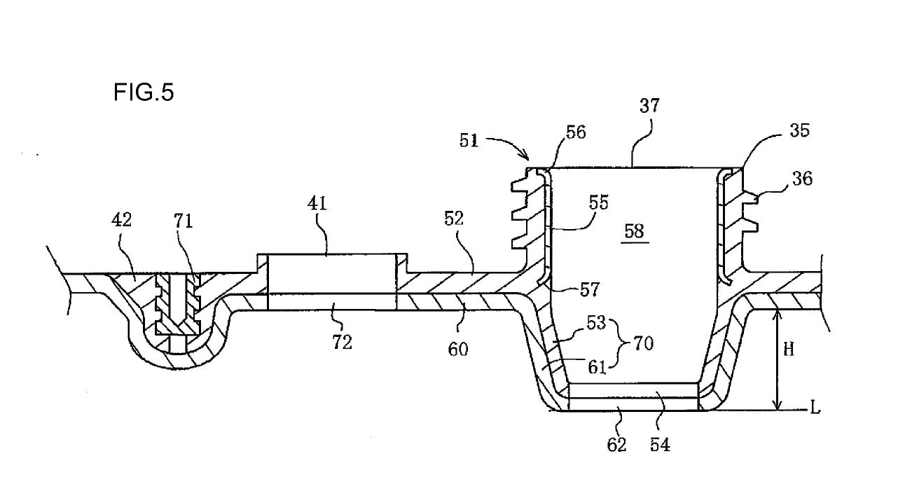

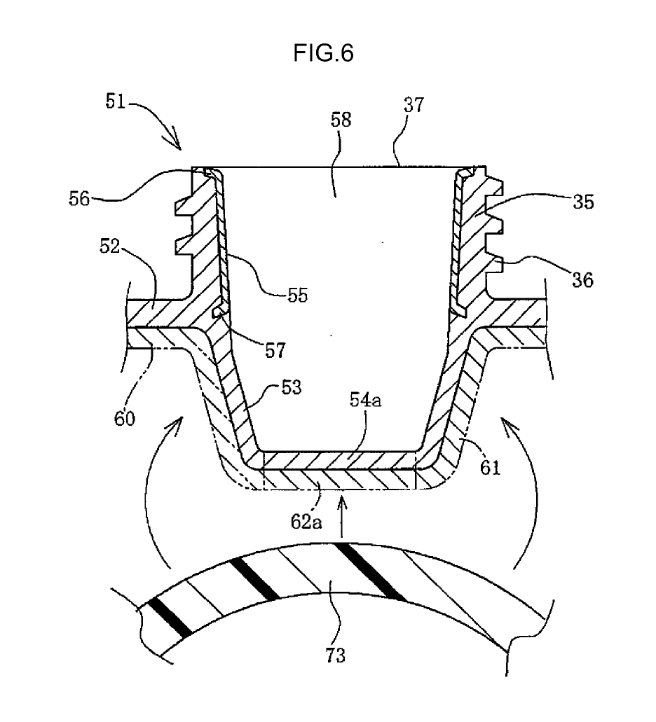

FIG. 4 shows an enlarged cross-sectional view of the fuel inlet part with a fuel cap 50 attached thereto. FIG. 5 shows a cross-sectional view taken along the line 5-5 in FIG. 3. FIG. 6 shows a fuel inlet component in blow-molding. As shown in FIGS. 4 and 5, the upstanding portion 35 is formed of a fuel inlet component 51 integrally formed with the flat portion 32. In other words, a portion protruding upward from the flat portion 32 of the fuel inlet component 51 serves as the upstanding portion 35.

The fuel inlet component 51 is formed by injection molding or the like using polyethylene resin or the like in advance separately from the fuel tank. A plate portion 52 forming a part of the flat portion 32 is integrally formed on the side surface of the fuel inlet component 51, and extends substantially horizontally. A part, located below the plate portion 52, of the fuel inlet component 51 forms a level plate portion 53 extending downward while being tapered downward. A lower opening 54 is formed in the lower end portion of the level plate portion 53 so as to communicate with the inside of the first fuel tank 20.

A cylindrical member 55 made of an appropriate metal such as iron is integrated on the inner circumferential side of the fuel inlet component 51 by insert molding. The cylindrical member 55 has a cylindrical shape being tapered downward, and upper and lower opening edges thereof are rolled outward to form opening portions 56, 57. The opening portions 56 and 57 bite into the thick wall of the fuel inlet component 51, thereby reinforcing the integration of the fuel inlet component 51 and the cylindrical member 55. The cylindrical member 55 is exposed at the intermediate portion thereof on the inner circumferential surface of the fuel inlet component 5 1.

The fuel inlet component 51 has a hole penetrating therethrough in the axial direction thereof. The hole forms a fuel inlet 58 and the upper end portion of the hole forms the opening portion 37 of the fuel inlet.

A part, below the plate portion 52, of the fuel inlet component 51 is integrated with an upper wall 60 of the first fuel tank 20. The upper wall 60 underlies the plate portion 52 and forms the flat portion 32 together with the plate portion 52. A part of the upper wall 60 forms an outer level plate portion 61 overlapping the outer side of the level plate portion 53. The level plate portion 53 and the outer level plate portion 61 are integrated to form a level plate 70.

A lower opening 62 is formed in the lower end portion of the outer level plate portion 61. The lower opening 62 is closed immediately after the blow molding, and the closed part is cut off together with a bottom portion, which is also closed, of the fuel inlet component 5 1, so that the lower openings 54 and 62 are simultaneously formed.

As shown in FIG. 4, a male thread 63 is formed on a part, above the plate portion 52, of the fuel inlet component 5 1, that is, on the outer circumferential part of the upstanding portion 35. An outer cylindrical portion 64 of the fuel cap 50 overlaps the outer side of the upstanding portion 35, so as to be fastened with a female thread 65 formed on the inner circumferential surface of the outer cylindrical portion 64. The upper portion of the outer cylindrical portion 64 forms a ceiling portion 66 where an inner cylindrical portion 67, which is inserted into the fuel inlet 58, is integrally formed.

On the outer circumferential side of the inner cylindrical portion 67, a packing 68 is disposed in a region surrounded by the ceiling portion 66 and the outer cylindrical portion 64, so that the opening portion 56 of the cylindrical member 55 is in contact with the packing 68 for sealing. In this way, a gap between the ceiling portion 66 and the upper end of the upstanding portion 35 is sealed. Reference numeral 69 denotes a vent hole.

As shown in FIG. 5, the plate portion 52 is integrated with the mounting seat 42 and the mounting hole 41 for mounting the fuel sensor. The mounting seat 42 is provided to surround the mounting hole 41 for the fuel sensor, and integrated with an insert nut 71 provided therein by insert molding. The upper wall 60 overlaps, and is integrated with, a part, where the mounting hole 41 is provided, of the plate portion 52 from below. An opening 72 matching the mounting hole 41 is formed at the position, corresponding to the mounting hole 4 1, in the upper wall 60 so as to be integrated with the mounting hole 41. Reference symbol H in the figure indicates the height of the level plate 70, while the horizontal line L at the lower end portion of the outer level plate portion 61 indicates the fluid level at the time when the fuel tank is filled up.

FIG. 6 is a view for describing the insert molding for the upstanding portion 35. When the fuel tank is formed by blow molding, the fuel inlet component 51 is set in an unillustrated mold in advance, and then, a parison 73 is expanded in the mold. A part of the expanded parison 73 thus overlaps the outer side of the level plate portion 53 so as to be tightly integrated with, the outer side, as the outer level plate portion 61. At this time, the level plate portion 53 has no opening portion formed at a bottom portion 54a thereof. The outer level plate portion 61 integrated after the blow molding is also integrate with a bottom portion 62a which corresponds to the lower opening 62 and which is cut off after the blow molding.

At the same time, the upper wall 60 overlaps the lower side of the plate portion 52 so as to be tightly integrated with the lower side. At this time, the mounting hole 41 (see FIG. 5) is also not formed. Then, the bottom portion 54a of the level plate portion 53 and the bottom portion 62a of the outer level plate 6 1, which are integrated with each other after the blow molding, are cut off together by blanking or the like, so that the lower openings 54 and 62 are formed. Also, the plate portion 52 and the upper wall 60 are cut off together at the portions thereof corresponding to the mounting hole 41 by blanking or the like, so that the mounting hole 41 and the opening 72 are formed (see FIG. 5).

Subsequently, the effect of this embodiment will be described. In FIGS. 4 to 6, when the fuel inlet component 51 is integrated with the flat portion 32 during the blow molding to form the upstanding portion 35, the fuel inlet component 51 has the level plate portion 53 integrally provided thereon. For this reason, the outer level plate portion 61 is integrated with this level plate portion 53 at the outer side thereof. As a result, these level plate portion 53 and outer level plate portion 61 constitute the level plate 70.

This eliminates the need for positioning each time, as in the case of a separate level plate being inserted into and attached to a fuel inlet having been molded. As a result, simple and precise positioning is achieved.

Also, since the fuel inlet component 5 1, separately formed in advance, and the main body 30 are integrally molded, any special fixing member or seal is unnecessary to be provided for the level plate 70. As in the conventional case, only the packing 69 provided between the upstanding portion 35 and the fuel cap 50 suffice for sealing, leading to reduction in the number of components, and to a simple structure.

In addition, the cylindrical member 55 made of a metal is integrated, by insert molding, in only the part, above the plate portion 52, of the fuel inlet component 51 corresponding to the upstanding portion 35. Accordingly, the toughness against falling down is improved, as well as the integration by the insert molding prevents looseness from occurring.

Obviously, numerous modifications and variations of the present invention are possible in light of the above teachings. It is therefore to be understood that within the scope of the appended claims, the invention may be practiced otherwise than as specifically described herein.

What is claimed as new and is desired to be secured by Letters Patent of the United States is:

1. A fuel inlet structure of a resin fuel tank, comprising:
an upstanding portion provided to the resin fuel tank molded by blow molding, the upstanding portion standing upright in a cylindrical form; and
a fuel inlet provided in the upstanding portion,
wherein the upstanding portion is formed by insert molding of a separate fuel inlet component in an integral manner during the blow molding of the tank, and
wherein the fuel inlet component integrally includes a level plate portion extending downward below an upper surface of the tank.

2. The fuel inlet structure of a fuel tank according to claim 1,
wherein the fuel inlet component is made of a resin material by injection molding, and
wherein a metallic ring is cast into the fuel inlet component during the injection molding.

3. A fuel inlet structure of a resin fuel tank, comprising:
a fuel inlet component connected to an upper surface of the resin fuel tank and comprising:
a plate portion connected to the upper surface of the resin fuel tank;
an upstanding portion projecting from the plate portion, a fuel inlet being provided in the upstanding portion;
a level plate portion extending downward below the upper surface of the resin fuel tank; and
the fuel inlet component being connected to the upper surface of the resin fuel tank while the resin fuel tank is blow molded.

4. A resin fuel tank comprising:
a fuel inlet component connected to an upper surface of the resin fuel tank and comprising:
a plate portion connected to the upper surface of the resin fuel tank;
an upstanding portion projecting from the plate portion, a fuel inlet being provided in the upstanding portion;
a level plate portion extending downward below the upper surface of the resin fuel tank; and
the fuel inlet component being connected to the upper surface of the resin fuel tank while the resin fuel tank is blow molded.

5. A method for manufacturing a resin fuel tank, the method comprising:
providing a fuel inlet component having a lower surface and comprising:
a plate portion having an upper face and a lower face;
an upstanding portion projecting from the upper face of the plate portion, a fuel inlet being provided in the upstanding portion; and
a level plate portion projecting from the lower face of the plate portion,
blow molding a resin material to stick to the lower surface of the fuel inlet component to form the resin fuel tank.
